(19) United States
(12) Patent Application Publication
(10) Pub. No.: US 2016/0209863 A1
(43) Pub. Date: Jul. 21, 2016

(54) Control Device for the Manual Control of Devices

(71) Applicant: Methode Electronics Malta Ltd., Birkirkara (MT)

(72) Inventor: Evan Stringos, Pieta (MT)

(21) Appl. No.: 14/993,788

(22) Filed: Jan. 12, 2016

(30) Foreign Application Priority Data
Jan. 20, 2015 (DE) 102015100808.4
Apr. 17, 2015 (DE) 102015105940.1
Apr. 17, 2015 (DE) 202015101932.7

(51) Int. Cl. G05G 5/06; H01H 3/00; G05G 1/10

(52) U.S. Cl. CPC G05G 5/06; G05G 1/10; H01H 3/00

(57) ABSTRACT

A control device (1) for the manual control of devices has a rotary knob (2) and a carrier (3) connected to the rotary knob (2). The carrier has a first indexing profile (4), a second indexing profile (5) and a non-indexing profile (6). The device has a plunger (7), a first movable indexing device (8), and a second movable indexing device (9). The first indexing device (8) and the second indexing device (9) allow for independent indexing positioning with respect to the first indexing profile (4) and the second indexing profile (5).

### RELATED APPLICATION DATA

This application claims the benefit of German Patent Application No. 10 2015 100 808.4, filed on Jan. 20, 2015, German Patent Application No. 10 2015 105 940.1, filed on Apr. 17, 2015, and German Utility Model No. 20 2015 101 932.7, filed on Apr. 17, 2015, the disclosures all of which are incorporated by reference herein.

### BACKGROUND AND SUMMARY

The invention relates to a control device for the manual control of devices comprising a rotary knob and a carrier which is connected to the rotary knob comprising at least one first indexing profile and at least one second indexing profile and at least one non-indexing profile, a plunger as well as at least one first movable indexing device and at least one second movable indexing device, wherein the said indexing devices allow an independent indexing position with respect to the first and second indexing profile.

Control devices for the manual control of devices are especially known in the motor vehicle sector. Such control devices are frequently arranged in the region of centre consoles of motor vehicles. They can be used to control various functions, e.g. the navigation system, the radio, Internet applications, music devices.

The electrical, electronic and/or software control of the aforementioned functions on which the control devices are based or by which they are influenced is generally known.

In many cases, such control devices have a centrally arranged knob which is rotatable about its vertical axis, can often be swivelled in four directions and be pressed downwards about a vertical axis, whereby various indexing positions can be selected in combination with rotary movements of the knob.

Various attempts have been made in the prior art to influence the haptics of such control devices in order to give the user a feedback about the selection and the occurrence of various operating positions resulting from the manual operation of the control device. However, the technical solutions suggested in this respect are all highly complex, failure-prone and expensive to manufacture. In addition, they often do not make use of these control devices easier for the user but, due to their complexness, demand too much of the latter.

DE 100 29 191 A1 discloses, for example, an electronically controlled liquid rotary knob as haptic control element. The rotary knob runs in a magnetorheological liquid. The viscosity is controlled via a magnetic field. Depending on the control of the magnetic field, the various detent positions are produced. The construction of such a control device is highly complicated, requires a complex control technology and is expensive to manufacture.

Furthermore, WO 2013/068482 A2 discloses a vehicle control for the manual control of vehicle devices comprising at least one rotary knob and at least one gear wheel which is connected to the rotary knob and is rotatably mounted on a rotational axis which is common to the rotary knob, further comprising at least one magnet element which is associated with at least one tooth of the gear wheel and is mounted in a stationary manner relative to a rotation of the gear wheel. The construction of this device is also highly complex, presupposes that problems in terms of magnet technology are overcome and is complicated to operate and very expensive to manufacture.

Moreover, these complicated devices using magnetic field technologies for changing haptics are combined with highly specific LED technologies as disclosed, for example, in WO 2013/068482.

In summary, the present prior art is characterized in that such control devices for the manual control of devices having a rotary knob only determine one single haptic profile. Therefore, in order to detect the different forces and the number of the respective indexing detents, two separate modules are necessary in order to fulfil the same function. Insofar as control devices exist which detect more than one haptic profile when being used, these devices are complex, failure-prone and in many cases demand too much of the user.

Based on this prior art, it is therefore the object of the present invention to detect two or more haptic profiles with one single rotary module; there should be no necessity to use a plurality of modules. Furthermore, the use of non-complex electromechanical systems is to be aimed at. In addition, easy but still safe operation of such a control device should be made possible for the user, enabling him to identify the intended and set indexing position due to the provision of at least two haptic profiles.

The control device for the manual control of devices according to the invention comprises a rotary knob which is arranged on a fixed housing which, in turn, is arranged on the centre console of a motor vehicle or any other base of a device. The rotary knob is rotatable about its vertical axis by 360°.

Advantageously, the rotary knob has a corrugated outer ring by means of which the user can move the rotary knob in a rotationally symmetric manner.

In addition, the rotary knob has a surface arranged on its upper front side which is independent of the rotary movement of the outer ring. For example, the front side can be configured in the form of a cap and is referred to as such for the sake of simplification. It can be actuated by the user, for example by being manually pressed in the vertical direction of the vertical axis.

By actuating, in particular pressing, the cap, a plunger disposed inside the rotary knob is actuated which, in the pressed state, impinges on a contact switch actuating, for example, a linear actuator. This will be described hereinafter in more detail.

A carrier arranged in the interior of the housing is connected to the rotary knob, in particular to the preferably corrugated outer ring.

Advantageously, the connection between the rotary knob, in particular the corrugated outer ring, and the carrier arranged in the interior of the housing is configured in a fixed manner.

By rotating the rotary knob, in particular the corrugated outer ring, the said carrier rotates as well.

Advantageously, the carrier is configured in the form of a three-dimensional ring.

The said carrier has at least two indexing profiles, namely at least one first indexing profile and one second indexing profile.

Preferably, the carrier has also at least one non-indexing profile.

The said profiles are preferably arranged at different height levels of the carrier, for example the three-dimensional ring.

When viewed from the bottom, the first indexing profile is first arranged on the vertical axis of the carrier. The second indexing profile is located above. At least one non-indexing profile is arranged adjacent to the second indexing profile.

The said indexing profiles are preferably arranged around the inner circumference of the carrier.

Preferably, the first indexing profile is a sawtooth-like profile. Particularly preferably, the sawtooth profile is triangle-shaped, wherein the angle projecting downwards from a vertical perspective is an obtuse angle.

Instead of a sawtooth-like profile, other comparable profiles may be provided for the first indexing profile, e.g. a wave-like profile. Combinations of such geometric designs are within the discretion of the person skilled in the art.

In a particularly preferred embodiment, the said first indexing profile has at least 6 to 9 such sawtooth-like or wave-like profile parts.

Preferably, the second indexing profile, which, from a vertical perspective, is arranged on top of the first indexing profile, also has such a sawtooth-like or wave-like configuration.

The second indexing profile includes a larger number of such profile segments. Without being a limitation in terms of contents, a number of 18 to 24 profile segments is considered preferable for many applications.

Due to the larger number of profile segments in the second indexing segment, a flattened contact surface or scanning surface is formed.

For the profile segments of the second indexing profile preferably have a lower configuration than the profile segments of the first indexing profile.

When viewed from the bottom in the vertical direction of the carrier, a so-called non-indexing profile is arranged adjacent to the second indexing profile, preferably above or below the second indexing profile. The said non-indexing profile is preferably configured in the form of a plain surface without the presence of profile segments as existing in the first and second indexing profile.

The profile segments of the first indexing profile and the second indexing profile each form a detent contour.

In addition to the aforementioned first and second indexing profiles, the carrier may also have one or several further indexing profiles. This depends largely on the intended purpose.

Depending on the intended purpose, the arrangement of the respective indexing profiles in relation to each other may also be different.

The height and the number of the aforementioned sawtooth segments and/or wave configurations determine the number of the respective achievable indexing positions.

The preferably different height profiles of the profile segments also influence the force to be applied for the actuation of the rotary knob in coaction with the actuation of the movable indexing devices described hereinafter which enter into a working interrelationship with the indexing profiles.

Due to the different configuration of the at least first and second indexing profiles, the different haptics is created, informing the user about the selection and the occurrence of various indexing positions.

Instead of the aforementioned sawtooth-like or wave-like configuration of the first indexing profile and the second indexing profile, it is, of course, also possible to choose inverse structures, for example hemispherical recesses of different sizes and depths, for the carrier.

Furthermore, the first indexing profile, the second indexing profile and the non-indexing profile may also be arranged on the outside of the carrier. In addition, they can be arranged alternately on the inside and the outside of the carrier.

In its interior, the device according to the invention also has at least one first movable indexing device and at least one second movable indexing device. The said movable indexing devices are also referred to as plungers.

The first movable indexing device is designed to enter into a working interrelationship with the first indexing profile of the carrier.

The second movable indexing device is designed to enter into a working interrelationship with the second indexing profile and the non-indexing profile of the carrier.

In particular, the second movable indexing device may have a ball which is capable of contacting the detent contour of the second indexing profile. The second movable indexing device, especially in the form of a ball, may be spring-loaded and, in particular, arranged on a compression spring. In this respect, the term “movable” does not refer to this spring load; the term will be explained hereinafter.

Preferably, the first movable indexing device is also spring-loaded. In particular, it may be connected to a compression spring.

The at least two movable indexing devices are arranged in an inner housing located beneath the plunger provided below the cap of the rotary knob.

The inner housing is arranged adjacent to the carrier.

It is open in an upper region facing the outside of the rotary knob. This allows the effective contact between the first indexing profile of the carrier and the first movable indexing device on the one hand and the second indexing profile of the carrier and the second movable indexing device on the other hand.

The second movable indexing device is in turn arranged in a movable component, for example a housing, which is in turn vertically movable within the said inner housing.

The second movable indexing device is preferably arranged at a right angle relative to the first movable indexing device.

Compared to the first movable indexing device, the second movable indexing device adopts a horizontal position and, compared to the vertical axis of the rotary knob, is thus arranged at an angle of 90°.

The housing of the second movable indexing device is preferably mounted on or at the upper front side of the first movable indexing device. The movability of the ball, which is loaded, in particular, by means of the compression spring, is not influenced by this mounting.

Preferably, the first movable indexing device is aligned vertically. The preferably provided compression spring rests on a base which is vertically movable in an upward and downward direction.

Due to this configuration, the first and second indexing devices are moved vertically from an approximately lower position to an upper position not only in an absolute manner but also with respect to the indexing profile arrangement of the adjacent carrier.

As a result of this movable configuration of the first indexing device and the second indexing device, the first movable indexing device can enter into a working interrelationship with the first indexing profile of the carrier, depending on the actuation of the control device by rotating and/or pressing. This takes place irrespective of whether and to what extent the second movable indexing device enters into a working interrelationship with the second indexing device of the carrier.

The first movable indexing device and the second movable indexing device are thus arranged in a vertically movable constellation. The release mechanism of this movability will be dealt with below.

Although the case-like device receiving the first movable indexing device and the second movable indexing device is vertically movable, as illustrated, it is fixed in the direction of rotation, i.e. it does not move together with the preferred outer ring of the rotary knob and the carrier arranged thereon in the circumferential direction of rotation.

This constellation thus means that, when the arrangement of the movable base and the movable component is positioned upwards, i.e. towards the cap of the rotary knob, the second movable indexing device is not in contact with the detent contour of the second indexing profile of the carrier. Rather, the second movable indexing device is able to move freely on the non-indexing profile of the carrier. As a result, the second movable indexing device is not in indexing contact with the second indexing profile of the carrier.

In this arrangement of the second movable indexing device, the contact is established only between the front side of the first movable indexing device and the detent contour of the first indexing profile of the carrier.

The first indexing device, which is moved upwards in this position, contacts the sawtooth-like or wave-like detent structure of the first indexing profile of the carrier.

Therefore, by rotating the carrier together with the outer ring of the rotary knob, the first movable indexing device follows the said sawtooth-like or wave-like detent contour. This leads to a relatively strong haptics.

If the movable component, preferably the case-like device, with the first movable indexing device and the second movable indexing device is positioned in the lower region of the rotary knob as compared to the vertical axis of the rotary knob, this arrangement has the effect that the indexing position of the two components is changed in comparison to the first indexing profile and the second indexing profile of the carrier. As a result, haptics is changed as well.

For, in this case, the second movable indexing device contacts the detent contour of the second indexing profile of the carrier. By rotating the outer ring of the rotary knob and thus the carrier about its vertical rotational axis, the second movable indexing device in the preferred embodiment of a ball mounted by means of a compression spring follows the detent contour of the second indexing profile of the carrier.

Since, as described above, this detent contour is preferably shorter and smoother compared to the detent contour of the first indexing profile of the carrier, the haptics perceived by the user changes.

In the last-mentioned configuration, the first movable indexing device is not in contact with the first indexing profile of the carrier.

The vertical movement of the case-like device receiving the first and second movable indexing device is carried out by a linear actuator. This linear actuator may be driven by a motor or in any other way, thus also manually. The only significant factor is that the linear actuator allows the control device to be switched from the first haptic profile to the second haptic profile as a result of the movement of the case-like device.

Preferably, the linear actuator is actuated by means of the contact switch located in the interior of the housing of the rotary knob. Preferably, this takes place when the user presses the cap of the rotary knob downwards in the vertical direction such that the plunger is also pressed downwards, thereby establishing contact with the contact switch.

In a second embodiment of the invention the first movable indexing device is shifted from an axial position into a parallel position in relation to the second movable indexing device.

This is advisable if the first movable indexing device should not contact a sawtooth-like but a wave-like detent structure of the first indexing profile of the carrier and if the number of the wave-like detent structure elements of said indexing profile should have a smaller deviation in respect of the number of the detent structure elements of the detent structure of the second indexing profile as it can be the case with the initially mentioned embodiment with a sawtooth-like configuration.

In the said other embodiment the first movable indexing device can likewise have a ball which can contact the detent contour of the first indexing profile. The first movable indexing device with a ball is preferably arranged on a compression spring in a spring-loaded manner.

Also the second movable indexing device with a ball is preferably arranged on a compression spring in a spring-loaded manner.

Instead of a ball also other designs can be chosen which allow a sliding movement or other movement along the relevant detent structure of the carrier, e.g. spring wire or bow-like shapes. This applies to all embodiments.

In this second embodiment a non-indexing profile is likewise arranged on the inner surface of the carrier, preferably between the first and the second indexing profile.

The first movable indexing device is designed to enter into a working interrelationship with the first indexing profile of the carrier.

The second movable indexing device is designed to enter into a working interrelationship with the second indexing profile and the non-indexing profile of the carrier.

Due to this configuration, also in this embodiment the first and the second indexing devices are moved vertically from an approximately lower position to an upper position not only in an absolute manner but also with respect to the indexing profile arrangement of the adjacent carrier.

As a result of this movable configuration of the first indexing device and the second indexing device, the first movable indexing device can enter into a working interrelationship with the first indexing profile of the carrier, depending on the actuation of the control device by rotating and/or pressing.

This constellation thus means that the second movable indexing device is not in contact with the detent contour of the second indexing profile of the carrier. Rather, the second movable indexing device is able to move freely on the non-indexing profile of the carrier. As a result, the second movable indexing device is not in indexing contact with the second indexing profile of the carrier.

In this arrangement of the second movable indexing device, the contact is established only between the front side of the first movable indexing device and the detent contour of the first indexing profile of the carrier.

The first indexing device, which is moved upwards in this position, contacts the wave-like detent structure of the first indexing profile of the carrier.

Therefore, by rotating the carrier together with the outer ring of the rotary knob, the first movable indexing device follows said wave-like detent contour.

If the movable component, preferably the case-like device, with the first movable indexing device and the second movable indexing device is positioned in the lower region of the rotary knob as compared to the vertical axis of the rotary knob, this arrangement has the effect that the indexing position of the two components is changed in comparison to the first indexing profile and the second indexing profile of the carrier. As a result, haptics is changed as well.

For, in this case, the second movable indexing device contacts the detent contour of the second indexing profile of the carrier. By rotating the outer ring of the rotary knob and thus the carrier about its vertical rotational axis, the second movable indexing device in the preferred embodiment of a ball mounted by means of a compression spring follows the detent contour of the second indexing profile of the carrier.

For example, the second embodiment can further be designed in that way that a further non-indexing profile is arranged on the inner surface of the carrier. In this case it is preferable, from a vertical perspective in the direction of the plunger, to arrange the second non-indexing profile for the second movable indexing device at the top on the inner surface of the carrier, below it the second indexing profile, below it the first indexing profile and again below it a further, first non-indexing profile.

Also in this case the first indexing profile shows a lower number of profile structure elements than it is the case with the second indexing profile, which involves different haptics depending on the actuation of the control device.

Accordingly, the movable component is arranged in the inside of the device with the first movable indexing device and the second movable indexing device received therein according to a second embodiment. From the aforementioned perspective, it has a first movable indexing device, below it a second movable indexing device with respectively one ball for sliding or other movement along the relevant detent structure of the carrier, with both movable indexing devices being in turn arranged in a spring-actuated inner housing.

Upon actuation of the rotary knob by rotating and/or pressing the plunger and thus also the carrier about its vertical rotational axis, the first movable indexing device enters into a working interrelationship with the first indexing profile of the carrier. For by rotating the outer ring of the rotary knob and thus also the carrier about its vertical rotational axis, the first movable indexing device in the preferred embodiment of a ball mounted by means of a compression spring follows the detent contour of the first indexing profile of the carrier.

The second movable indexing device is then at the height of the second non-indexing profile of the carrier, thus in a non-indexing state.

Upon further actuation of the rotary knob by rotating and/or pressing the plunger and thus also the carrier about its vertical rotational axis, the second movable indexing device enters into a working interrelationship with the second indexing profile of the carrier. For by rotating the outer ring of the rotary knob and thus the carrier about its vertical rotational axis, the second movable indexing device in the preferred embodiment of a ball mounted by means of a compression spring follows the detent contour of the second indexing profile of the carrier.

The first movable indexing device is then at the height of the first non-indexing profile of the carrier, thus in a non-indexing state.

The operating mode of these two partial configurations of a second embodiment correspond in principle to that of the initially explained embodiment so that its description can also be used for this embodiment.

A further, third embodiment is a kind of variant of the two embodiments described above.

This embodiment comprises for example like the first embodiment the first movable indexing device and a sawtooth-like first indexing profile on the carrier. But, in addition, at least one third indexing profile is present on the carrier in addition to the second indexing profile.

According to the chosen description, this third indexing profile is arranged between the first indexing profile and the second indexing profile of the carrier according to the initially explained embodiment.

The second and the third indexing profile preferably have a wave-like configuration which, in comparison to each other, show a different number of wave segments but at least preferably a larger number of wave segments in comparison to the number of the sawtooths of the first indexing profile. Especially the second indexing profile can be a constructive combination of a sawtooth-like and a wave-like profile.

A second movable indexing device as described in connection with the first embodiment is associated to the second and the third indexing profile, which follows either the first or the second indexing profile when the rotary knob is actuated as already described.

Also in this respect a non-indexing profile is provided, which from a vertical perspective is preferably arranged between the third indexing profile and the plunger of the rotary knob.

The inner housing which is preferably provided also in this embodiment thus moves over three indexing profile positions.

In the first position, the first movable indexing device is in contact with the first indexing profile of the carrier. The second movable indexing device is then in a non-indexing position.

In the second position, the first movable indexing device is in non-indexing position. The second movable indexing device is in contact with the second indexing profile.

In the third position, the first movable indexing device is in non-indexing position. The second movable indexing device is in contact with the third indexing profile.

The operating mode of this embodiment corresponds in principle to that of the initially explained embodiment so that its description can also be used for this embodiment.

Further combinations of these aforementioned embodiments are possible.

For example, it is possible that at least one non-indexing profile, unlike the embodiments explained above and hereinafter, is not arranged on the outer face of the indexing profiles but between the indexing profiles. This applies also if more than one non-indexing profile is used.

The expert will make a suitable selection of arrangements depending on the intended use of the control device. It results herefrom that also more than two indexing profiles can be used.

This applies also to the selection of the respectively favoured contour depending on the haptics aimed at.

### BRIEF DESCRIPTION OF THE DRAWINGS

Advantages and usefulness are revealed in the following description in conjunction with the drawings, in which:

FIG. 1 shows an exterior perspective view of the control device according to an embodiment of the invention;

FIG. 2 shows a perspective cross-sectional view of the control device according to the invention in accordance with the embodiment of the invention;

FIG. 3 shows a perspective view of the control device according to the invention, illustrating the rotary movement about the vertical axis and the vertical movement of the indexing devices;

FIG. 4 shows a top view of the carrier with the indexing profiles;

FIG. 5 shows a bottom view according to the embodiment of the invention of the carrier according to FIG. 4 and the indexing profiles;

FIG. 6 shows the movable component with the first movable indexing device and the second movable indexing device received therein;

FIG. 7 shows a perspective view of a vertical section through the control device according to the invention in a first indexing position;

FIG. 8 shows a perspective view of a vertical section through the control device according to the invention in a second indexing position;

FIG. 9 shows a perspective view of a vertical section through the control device according to the invention with the arrangement and the functional principle of the linear actuator;

FIG. 10 shows the control device according to the invention in a perspective cross-sectional view according to a variant of a second embodiment of the invention, where the first movable indexing device is in an indexing position;

FIG. 11 shows the control device according to the invention in a perspective cross-sectional view according to a variant of a second embodiment of the invention, where the first movable indexing device is in a non-indexing position;

FIG. 12 shows the movable component with the first movable indexing device and the second movable indexing device received therein according to a second embodiment;

FIG. 13 shows in a bottom view according to a second embodiment of the invention the carrier and the indexing profiles according to this embodiment;

FIG. 14 shows the carrier with a first movable indexing device and a sawtooth-like first indexing profile on the carrier as well as in addition to the second indexing profile at least one third indexing profile on the carrier according to a further embodiment.

### DETAILED DESCRIPTION

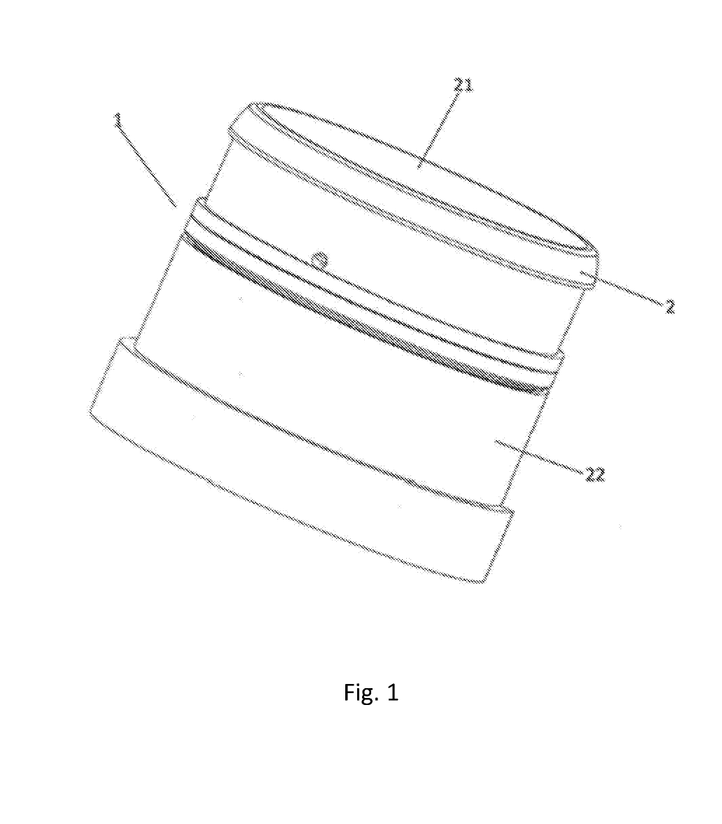

FIG. 1 shows the control device 1 for the manual control of devices according to the invention. The control device 1 comprises a rotary knob 2 which is arranged on a fixed housing 22 which is in turn arranged, for example, on the centre console of a motor vehicle or any other base of a device. The rotary knob is rotatable about its vertical axis by 360°.

Advantageously, the rotary knob has a corrugated outer ring 2 by means of which the user can move the rotary knob in a rotationally symmetric manner.

In addition, the rotary knob has a surface 21 arranged on its upper front side which is independent of the rotary movement of the outer ring. In this exemplary embodiment, the front side is configured in the form of a cap. It can be actuated by the user by being manually pressed, for example, in the vertical direction of the vertical axis.

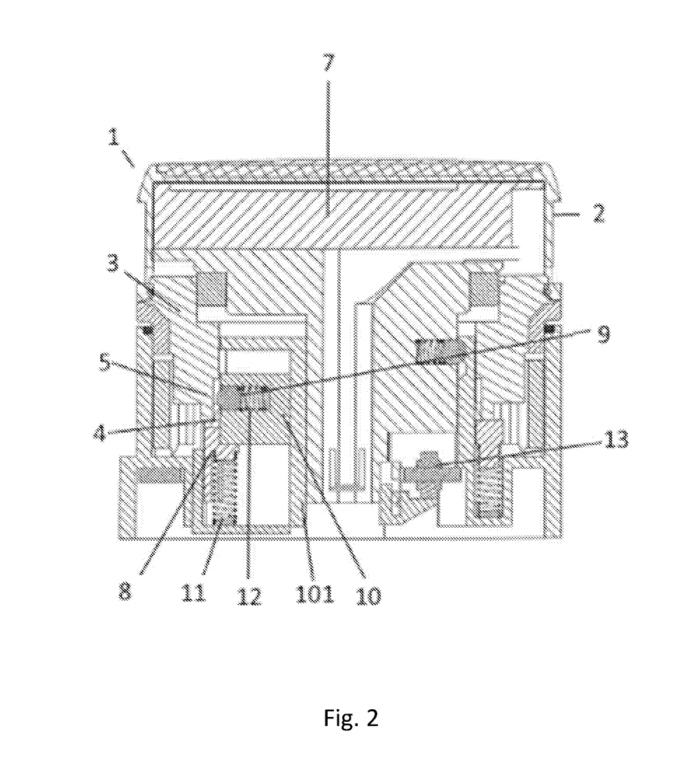

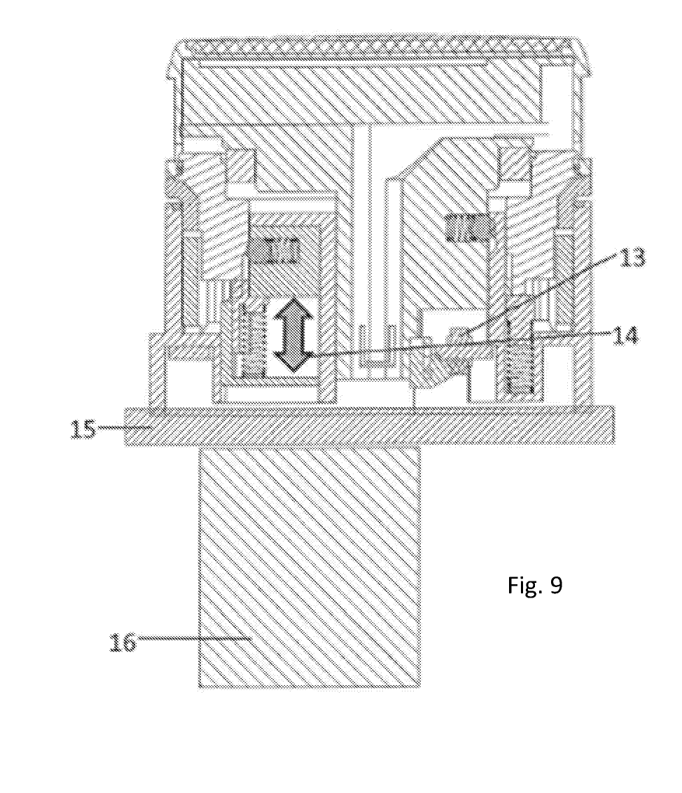

As can be seen from FIG. 2 and FIG. 9, by actuating, in particular pressing, the cap, a plunger 7 disposed inside the rotary knob is actuated which, in the pressed state, impinges on a contact switch 13 actuating, for example, a linear actuator. This will be described hereinafter in more detail.

A carrier 3 arranged in the interior of the housing is connected to the rotary knob 2, in particular to the preferably corrugated outer ring.

Advantageously, the connection between the rotary knob, in particular the corrugated outer ring, and the carrier arranged in the interior of the housing is configured in a fixed manner.

By rotating the rotary knob 2, in particular the corrugated outer ring, the said carrier 3 rotates as well.

The carrier 3 is configured in the form of a three-dimensional ring.

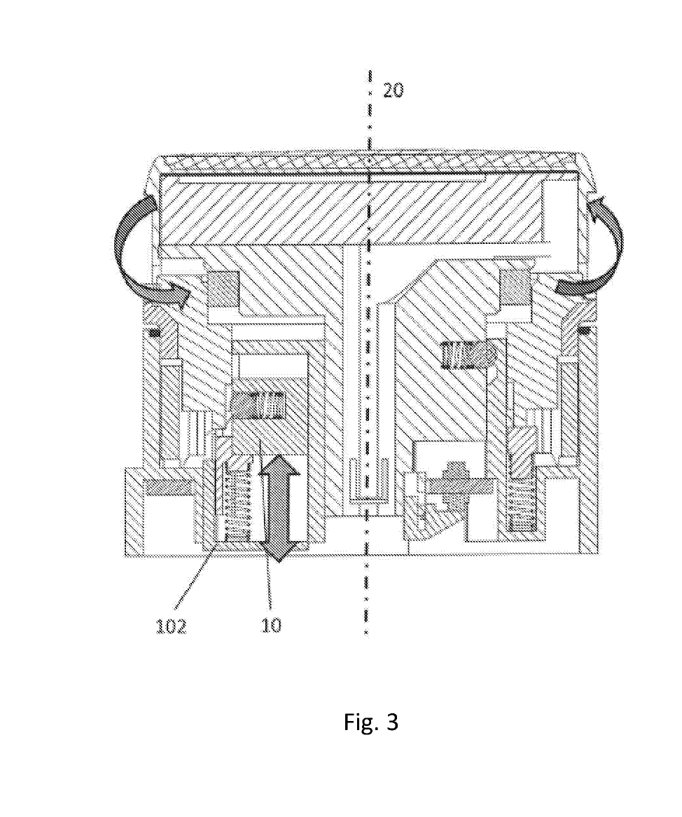

FIG. 3 shows the aforementioned constellation, illustrating an arrangement of rotation and the vertical movement of the indexing devices.

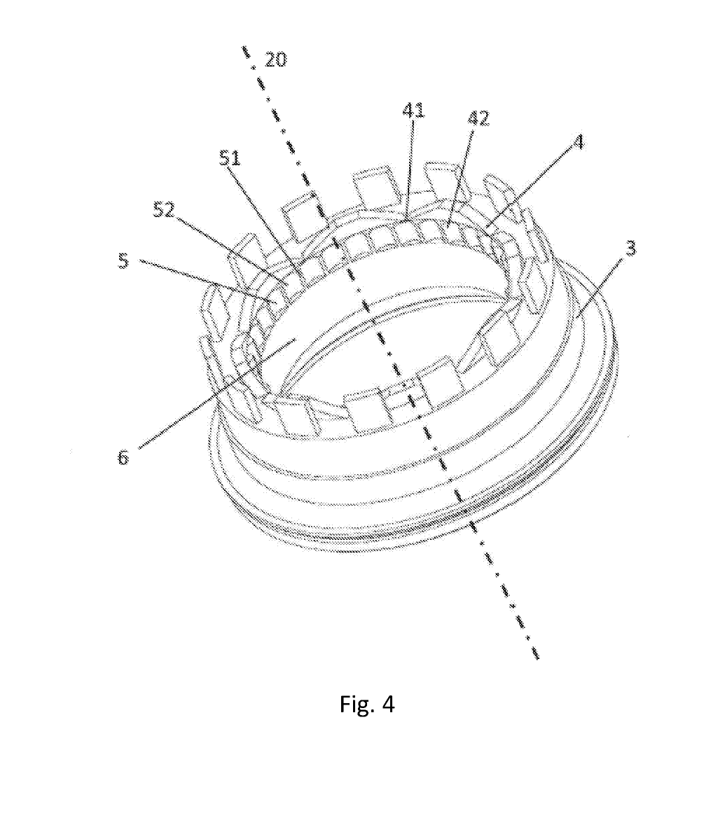

As can be seen from FIG. 4, the carrier 3 has at least two indexing profiles, namely at least one first indexing profile 4 and a second indexing profile 5.

In addition, the carrier 3 has a non-indexing profile 6.

The said profiles are preferably arranged at different height levels of the carrier.

When viewed from the bottom, the first indexing profile 4 is first arranged on the vertical axis 20 of the carrier. The second indexing profile 5 is disposed above. A non-indexing profile 6 is arranged on top of the second the second indexing profile.

The said indexing profiles are arranged around the inner circumference of the carrier.

The first indexing profile has a sawtooth-like profile 42. The sawtooth profile is triangle-shaped, wherein the angle projecting downwards from a vertical perspective is an obtuse or flat angle.

The said first indexing profile has approximately 8 such sawtooth-like profile parts.

The second indexing profile 5, which, from a vertical perspective, is arranged on top of the first indexing profile 4, has a wave-like configuration 52.

The second indexing profile includes a larger number of such profile segments 52.

The profile segments 52 of the second indexing profile 5 have a lower configuration than the profile segments 42 of the first indexing profile 4.

When viewed from the bottom in the vertical direction, a so-called non-indexing profile 6 is arranged above the second indexing profile. The non-indexing profile is configured in the form of a plain surface without the presence of profile segments as existing in the first and second indexing profile.

The profile segments of the first indexing profile and the second indexing profile each form a detent contour 41 and 51.

The height and the number of the aforementioned sawtooth segments and/or wave configurations determine the number of the respective achievable indexing positions. The different height profiles of the profile segments also influence the force to be applied for the actuation of the rotary knob in coaction with the actuation of the movable indexing devices 8 and 9.

Due to the different configuration of the at least first and second indexing profiles, the different haptics is created, informing the user about the selection and the occurrence of various indexing positions.

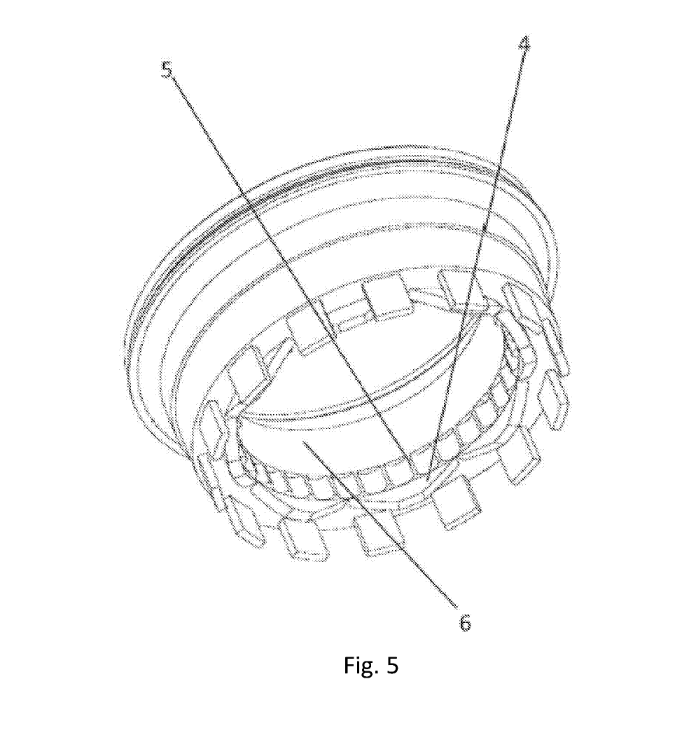

FIG. 5 shows the carrier 3 described in FIG. 4 in the mounting direction of the control device according to the invention, i.e. rotated by 180°.

According to FIGS. 2, 3, 6 and 7, the device according to the invention also has at least one first movable indexing device 8 and at least one second movable indexing device 9 in its interior. The said movable indexing devices are also referred to as plungers.

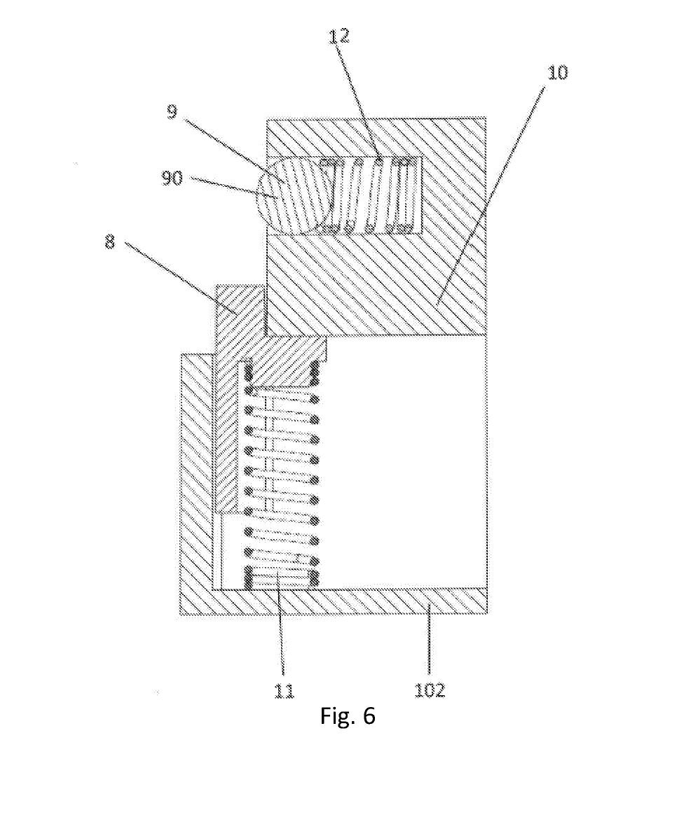

FIG. 6 shows an enlarged view of the said indexing devices.

The first movable indexing device 8 is designed to enter into a working interrelationship with the first indexing profile 4 of the carrier 3.

The second movable indexing device 9 is designed to enter into a working interrelationship with the second indexing profile 5 and the non-indexing profile 6 of the carrier 3.

The second movable indexing device 9 has a ball which is capable of contacting the detent contour 52 of the second indexing profile 5. The second movable indexing device configured in the form of a ball is spring-loaded and arranged on a compression spring.

The first movable indexing device 8 is spring-loaded and connected to a compression spring 11.

The two movable indexing devices 8 and 9 are arranged in an inner housing 101 which is located beneath the plunger 7 provided below the cap 21 of the rotary knob 2 and which is open in an upper region facing the outside of the rotary knob, thus allowing the effective contact between the first indexing profile 4 of the carrier 3 and the first movable indexing device 8 on the one hand and the second indexing profile 5 of the carrier 3 and the second movable indexing device 9 on the other hand.

The second movable indexing device 9 is in turn arranged in a movable housing 10 which, in turn, is vertically movable within the said inner housing 101.

The second movable indexing device in this example is arranged at a right angle relative to the first movable indexing device, FIG. 6.

Compared to the first movable indexing device, the second movable indexing device adopts a horizontal position and, compared to the vertical axis of the rotary knob, is thus arranged at an angle of 90°.

The housing 10 of the second movable indexing device 9 is mounted on or at the upper front side of the first movable indexing device 8. The movability of the ball 90, which is loaded, in particular, by means of the compression spring, is not influenced by this mounting.

The first movable indexing device 8 is aligned vertically. The compression spring 11 provided rests on a base 102 which is vertically movable in an upward and downward direction, FIGS. 3, 5.

As a result of this movable configuration of the first indexing device 8 and the second indexing device 9, the first movable indexing device 8 can enter into a working interrelationship with the first indexing profile 4 of the carrier 3, depending on the actuation of the control device by rotating and/or pressing. This takes place irrespective of whether and to what extent the second movable indexing device 9 enters into a working interrelationship with the second indexing device 5 of the carrier 3.

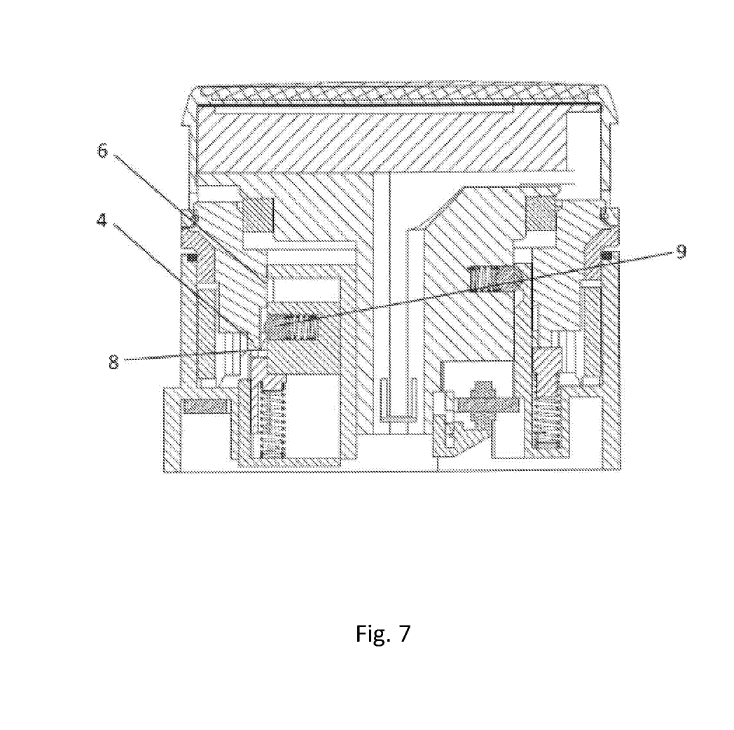

FIG. 7 shows a first position according to which, when the arrangement is positioned upwards, i.e. towards the cap 21 of the rotary knob 2, the second movable indexing device 9 is not in contact with the detent contour 52 of the second indexing profile 5 of the carrier 3. Rather, the second movable indexing device 9 is able to move freely on the non-indexing profile 6 of the carrier 3. As a result, the second movable indexing device 9 is not in indexing contact with the second indexing profile 5 of the carrier 3.

In this arrangement of the second movable indexing device 9, the contact is established between the front side of the first movable indexing device 8 and the detent contour 41 of the first indexing profile 4 of the carrier 3.

Although the case-like device 10 receiving the first movable indexing device 8 and the second movable indexing device 9 is vertically movable, as illustrated in FIG. 3, it is fixed in the direction of rotation, i.e. it does not move together with the preferred outer ring 2 of the rotary knob and the carrier 3 arranged thereon in the circumferential direction of rotation.

The first indexing device 8, which is moved upwards in this position, contacts the sawtooth-like detent structure 41 of the first indexing profile 4 of the carrier 3. Therefore, by rotating the carrier 3 together with the outer ring of the rotary knob 2, the first movable indexing device 8 follows the sawtooth-like detent structure 41. This leads to a relatively strong haptics.

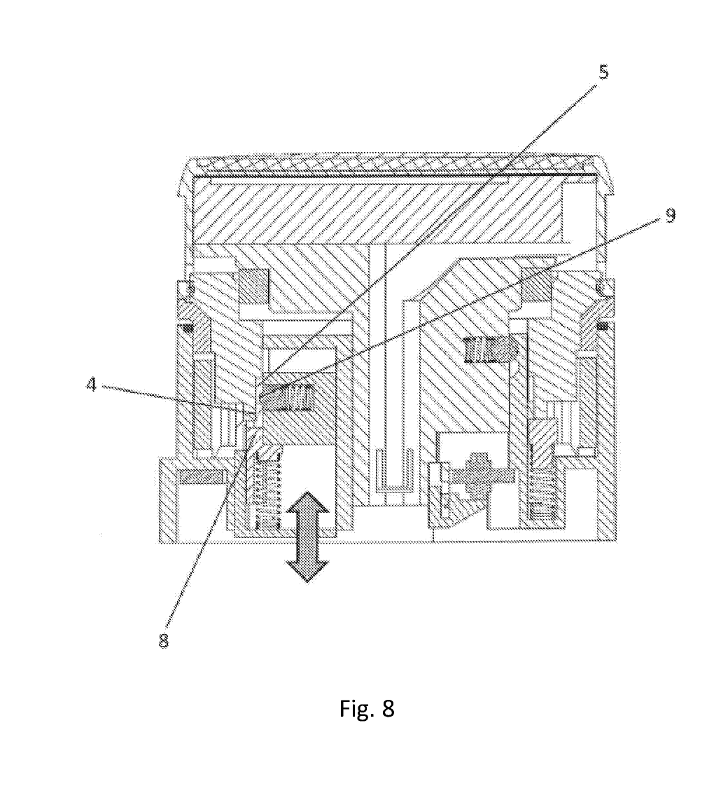

FIG. 8 shows a second position of the arrangement. Here, the case-like device 10 with the first movable indexing device 8 and the second movable indexing device 9 is located in the lower region of the control device as compared to the vertical axis of the rotary knob 2. This arrangement has the effect that the indexing position of the two components is changed in comparison to the first indexing profile 4 and the second indexing profile 5 of the carrier 3. As a result, haptics is changed as well.

For, in this case, the second movable indexing device 9 contacts the detent contour 52 of the second indexing device of the carrier.

By rotating the outer ring 2 of the rotary knob and thus the carrier 3 about its vertical rotational axis 20, the second movable indexing device 9 with the ball 90 follows the detent contour 51 of the second indexing profile 5 of the carrier 3. Since this detent contour 51 is preferably shorter and smoother compared to the detent contour 41 of the first indexing profile 4 of the carrier 3, the haptics perceived by the user changes.

In the last-mentioned configuration according to FIG. 8, the first movable indexing device 8 is not in contact with the first indexing profile 4 of the carrier 3.

As can be seen from FIG. 9, the vertical movement of the case-like device receiving the first and second movable indexing device is carried out by a linear actuator 14. The linear actuator 14 may be driven by a motor or in any other way. The only significant factor is that the linear actuator 14 allows the control device to be switched from the first haptic profile to the second haptic profile as a result of the movement of the case-like device 10.

Preferably, the linear actuator is actuated by means of the contact switch 13 located in the interior of the housing of the rotary knob. Preferably, this takes place when the user presses the cap 21 of the rotary knob 2 downwards in the vertical direction such that the plunger 7 is also pressed downwards, thereby establishing contact with the contact switch 13.

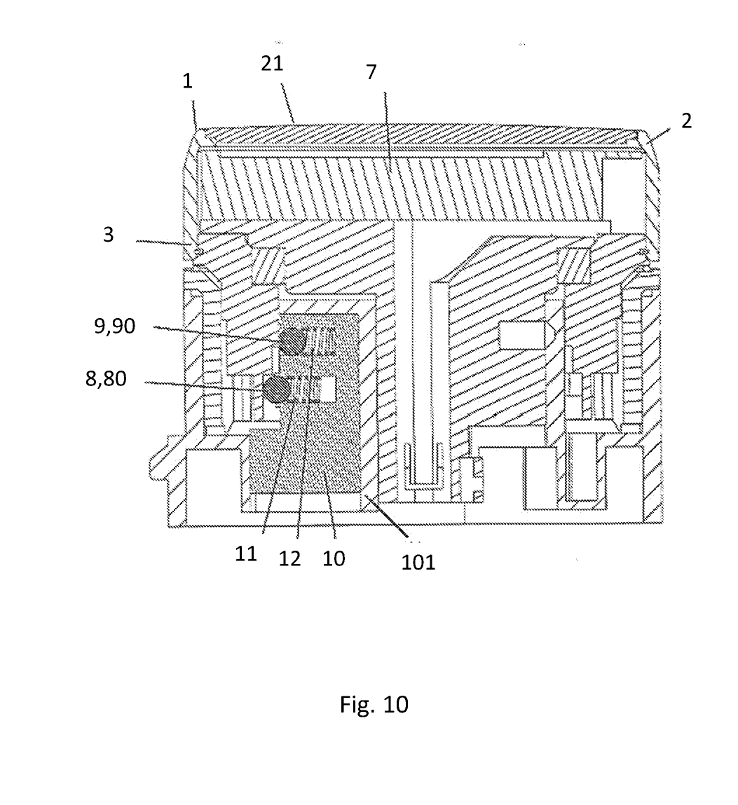

FIG. 10 shows a variant of a second embodiment of the invention. The basic structure of the control device corresponds essentially to that according to FIG. 2, 9, unless otherwise mentioned below.

Upon actuation of the rotary knob 2 by rotating and/or pressing the plunger and thus also the carrier 3 about its vertical rotational axis, the first movable indexing device 8, 80 enters into a working interrelationship with the first indexing profile 4 (not shown) of the carrier 3. For by rotating the outer ring of the rotary knob and thus the carrier about its vertical rotational axis, the first movable indexing device 8 in the embodiment of the ball 80 mounted by means of a compression spring 11 follows the wave-like detent contour 41 (not shown) of the first indexing profile 4 of the carrier 3.

This takes place regardless of whether and to what extent the second movable indexing device 9 enters into a working interrelationship with the second indexing profile 5 of the carrier 3.

The second movable indexing device 9 is then at the height of the, in this exemplary embodiment, second non-indexing profile 6 of the carrier 3, thus in a non-indexing state.

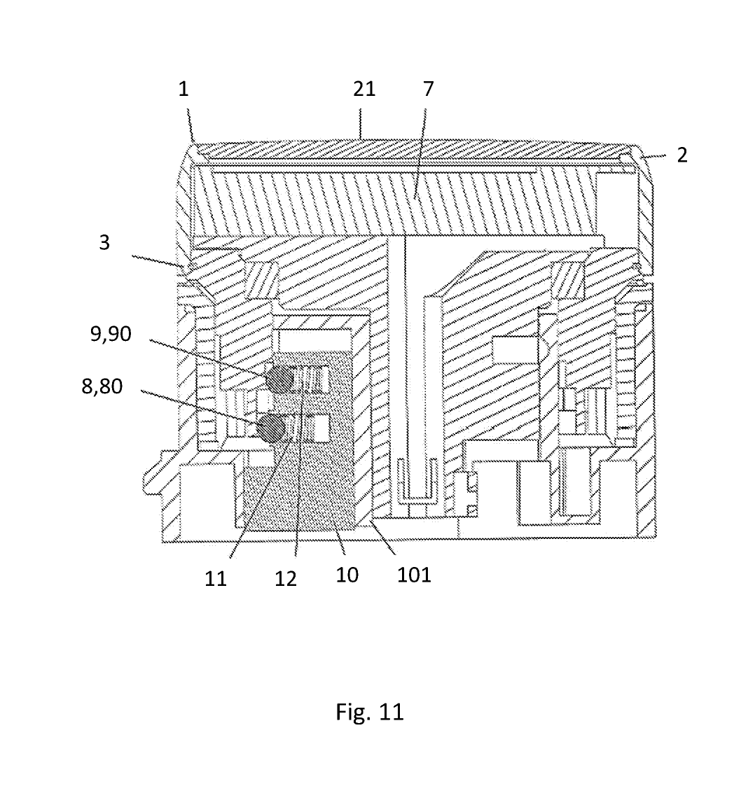

FIG. 11 shows the control device according to the invention in a perspective cross-sectional view according to this variant of a second embodiment of the invention, where the first movable indexing device is in a non-indexing position.

Upon further actuation of the rotary knob 2 by rotating and/or pressing the plunger 7 and thus also the carrier 3 about its vertical rotational axis, the second movable indexing device 9 enters into a working interrelationship with the second indexing profile 5 of the carrier. For by rotating the outer ring of the rotary knob 2 and thus also the carrier 3 about its vertical rotational axis 20 (not shown), the second movable indexing device 9 in the embodiment of the ball 90 mounted by means of a compression spring 12 follows the detent contour 51 (not shown) of the second indexing profile 5 of the carrier 3.

The first movable indexing device 8 is then at the height of the, in this exemplary embodiment, first non-indexing profile 600 (not shown) of the carrier, thus in a non-indexing state.

As this detent structure 51 is preferably shorter and smoother in comparison to the detent structure 41 of the first indexing profile 4 of the carrier 3, different haptics for the user are caused hereby.

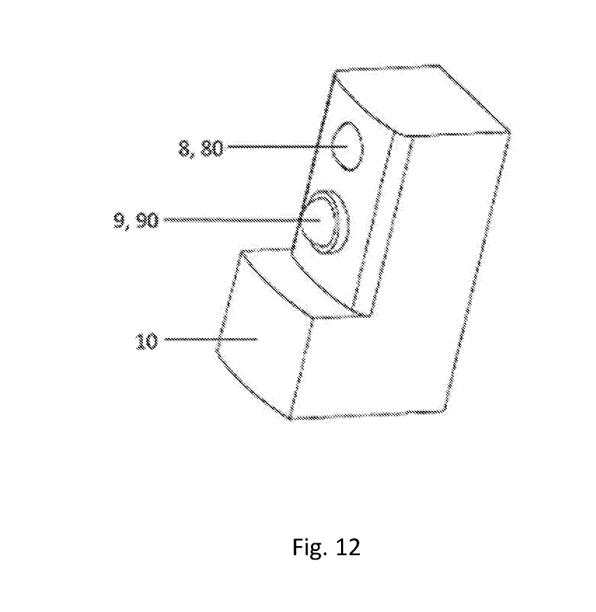

FIG. 12 shows the movable component with the first movable indexing device 8, 80 and the second movable indexing device 9, 90 received therein according to the second embodiment.

The first movable indexing device 8 is designed to enter into a working interrelationship with the first indexing profile 4 of the carrier 3 as well as the first non-indexing profile 600 (not shown) referred to in that way in this example.

The second movable indexing device 9 is designed to enter into a working interrelationship with the second indexing profile 5 and the second non-indexing profile 6 (not shown), referred to in that way in this example, of the carrier 3.

The second movable indexing device 9 has a ball 90 which contacts the detent contour 51 of the second indexing profile 5 (not shown). The second movable indexing device 9, in the form of a ball 90, is arranged on a compression spring 12 in a spring-loaded manner.

The first movable indexing device 8 is mounted in a spring-loaded manner and connected to a compression spring 11.

The two movable indexing devices 8 and 9 are arranged in an inner housing 101, which is located beneath the plunger 7 provided below the cap 21 of the rotary knob 2 and which is open in an upper region facing the outside of the rotary knob, thus allowing the effective contact between the first indexing profile 4 of the carrier 3 and the first movable indexing device 8 on the one hand and the second indexing profile 5 of the carrier and the second movable indexing device 9, as shown in FIG. 10, 11.

The second movable indexing device 9 is in turn arranged in a movable housing 10 which, in turn, is vertically movable within said inner housing 101, as shown in FIG. 10, 11.

The second movable indexing device 9, 90 in this example is arranged more or less parallel to the first movable indexing device 8, 80, as also shown in FIG. 10, 11.

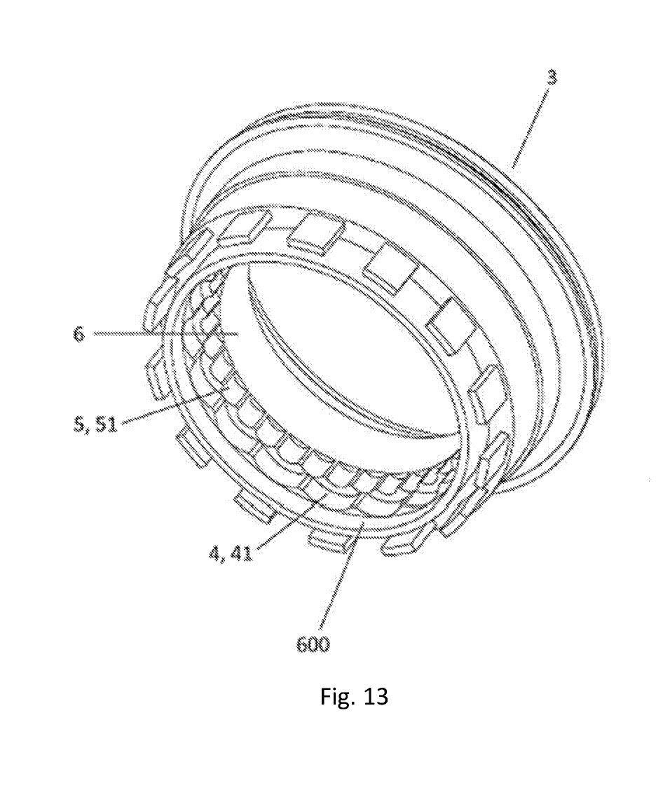

FIG. 13 shows in a bottom view according to the second embodiment of the invention the carrier 3 and the indexing profiles according to this embodiment.

The carrier 3 has two wave-like indexing profiles 4, 5 for the contact with the first and second indexing devices arranged in parallel.

In terms of function, the shifted wave-like indexing profile 4, 41 assumes the function of the sawtooth-like indexing profile 4, 41 according to FIG. 4, 5.

The wave-like indexing profile 4, 41 has in comparison to the sawtooth-like indexing profile 4, 41 according to FIG. 4, 5 a larger number of profile elements, which causes softer haptics.

In addition, the carrier 3 has a second non-indexing profile 6, referred to in that way in this example, as well as a first non-indexing profile 600 referred to in that way in this example.

These profiles are arranged at different height levels of the carrier.

When viewed from the bottom, the first non-indexing profile 600, referred to in that way in this example, is first arranged on the vertical axis 20 of the carrier, and above the first indexing profile 4. The second indexing profile 5 is located above. The second non-indexing profile 6, referred to in that way in this example, is arranged on top of the second indexing profile 5.

As a result of this movable configuration of the first indexing device 8 and the second indexing device 9, the first movable indexing device 8 can enter into a working interrelationship with the first indexing profile 4 of the carrier 3, depending on the actuation of the control device by rotating and/or pressing. This takes place independently of whether and to what extent the second movable indexing device 9 enters into a working interrelationship with the second indexing profile 5 of the carrier 3.

The first indexing device 8 contacts the wave-like detent structure 41 of the first indexing profile 4 of the carrier 3. Therefore, by rotating the carrier 3 together with the outer ring of the rotary knob 2, the first movable indexing device 8 with the ball 80 follows the wave-like detent contour 41.

By rotating the outer ring 2 of the rotary knob and thus the carrier 3 about its vertical rotational axis 20, the second movable indexing device 9 with the ball 90 follows the detent structure 51 of the second indexing profile 5 of the carrier 3.

In this respect reference is made to the explanations regarding FIG. 10, 11, 12.

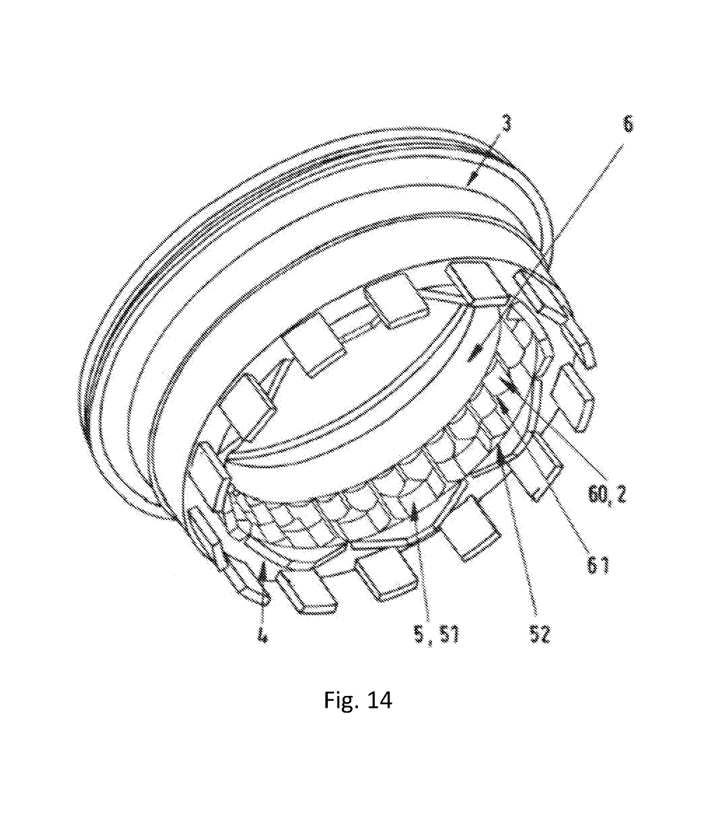

FIG. 14 shows the carrier with a first movable indexing device and a sawtooth-like first indexing profile on the carrier as well as in addition to the second indexing profile one at least third indexing profile on the carrier according to a third embodiment.

This embodiment comprises like the first embodiment the first movable indexing device 8 and a sawtooth-like 41 first indexing profile 4 on the carrier 3. But, in addition to the second indexing profile 5, a third indexing profile 60 is present on the carrier 3. According to the chosen description, this third indexing profile is arranged between the first indexing profile and the second indexing profile of the carrier according to the initially explained embodiment.

Both indexing profiles 5, 60 have a wave-like detent contour 51, 61 with detent contour segments 52, 62 which, in comparison to each other, have a different number of detent contour segments 52, 62 but at least preferably a larger number of detent contour segments 52, 62 in comparison to the number of the sawtooth-like detent contour segments 42 of the first indexing profile 4.

A second movable indexing device 9 as described in connection with the first embodiment is associated to the second 5 and the third 60 indexing profile, which follows either the first 4 or the second 5 indexing profile when the rotary knob is actuated as already described.

Also in this respect a non-indexing profile is provided. It is arranged between the second 5 and the third 60 indexing profile but can also be loated between the first 4 and the second 5 indexing profile.

In the first position, the first movable indexing device 8 (not shown) is in contact with the first indexing profile 4 of the carrier 3. The second movable indexing position 9 (not shown) is then in a non-indexing position 6.

In the second position, the first movable indexing device 8 (not shown) is in non-indexing position 6. The second movable indexing device 9 (not shown) is in contact with the second indexing profile 5.

In the third position, the first movable indexing device 8 (not shown) is in non-indexing position 6. The second movable indexing device 9 (not shown) is in contact with the third indexing profile 60.

### LIST OF REFERENCE NUMERALS

1 control device
2 rotary knob
3 carrier
4 first indexing profile
5 second indexing profile
6 non-indexing profile
7 plunger
8 first movable indexing device
9 second movable indexing device
10 vertically movable component
11 spring arrangement
12 spring arrangement
13 contact switch
14 linear actuator
15 socket
16 motor
20 vertical axis
21 cap
22 fixed housing
41 detent contour
42 detent contour segment
51 detent contour
52 detent contour segment
60 indexing profile
61 detent contour
62 detent contour segment
80 ball
90 ball
101 inner housing
102 vertically movable base
600 further non-indexing profile

1. A control device (1) for the manual control of devices, comprising:
a rotary knob (2),
a carrier (3) connected to the rotary knob (2), having a first indexing profile (4), and a second indexing profile (5), and at least one non-indexing profile (6),
a plunger (7),
a first movable indexing device (8),
a second movable indexing device (9),
wherein the first movable indexing device (8) and the second movable indexing device (9) allow an independent indexing position with respect to the first indexing profile (4) and the second indexing profile (5).

2. The control device according to claim 1, characterized in that the carrier (3) has at least one further non-indexing profile (6).

3. The control device according to claim 1, characterized in that the first movable indexing device (8) and the second movable indexing device (9) are arranged in a vertically movable component (10).

4. The control device according to claim 1, characterized in that the one first movable indexing device (8) and the second movable indexing device (9) are arranged at an angle relative to each other.

5. The control device according to claim 1, characterized in that the first movable indexing device (8) and the second movable indexing device (9) are arranged generally in parallel to each other.

6. The control device according to claim 1, characterized in that the first movable indexing device (8) and the second movable indexing device (9) are associated to at least one further indexing profile (60, 61, 62).

7. The control device according claim 1, characterized in that the first movable indexing device (8) and the second movable indexing device (9) are mounted on a spring arrangement (11, 12).

8. The control device according to claim 1, characterized in that the first indexing profile (4) is configured in the form of a detent contour (41).

9. The control device according to claim 1, characterized in that the second indexing profile (5) is configured in the form of a detent contour (51).

10. The control device according to claim 6, characterized in that the at least one further indexing profile (60) is configured in the form of a detent structure (61).

11. The control device according claim 1, characterized in that the first indexing profile (4) and the second indexing profile (5) are configured in the form of a first detent contour (41) and a second detent contour (51), respectively, the first and second detent contours (41,51) being configured differently.

12. The control device according claim 6, characterized in that the first indexing profile (4), the second indexing profile (5), and the at least one further indexing profile (60) are configured in the form of a first detent contour (41), a second detent contour (51) and a third detent contour (61), respectively, the first, second and third detent contours (41,51) being configured differently.

13. The control device according to claim 3, characterized in that the vertically movable component (10) is arranged in a rotationally fixed manner.

14. The control device according to claim 8, characterized in that the first detent contour (41) is configured in such a manner that the first detent contour causes different haptics when using the control device.

15. The control device according to claim 9, characterized in that the second detent contour (51) is configured in such a manner that the second detent contour causes different haptics when using the control device.

16. The control device according to claim 8, characterized in that, in a first position of the control device, the second movable indexing device (9) is able to move freely on the non-indexing profile (6), while the first indexing profile (4) and the first detent contour (41) of the first movable indexing device (8) is engaged.

17. The control device according to claim 17, characterized in that, in a second position of the control device, the second movable indexing device (9) is in an indexing position with the indexing profile (5) engaged in a second detent contour (51), while the first indexing profile (4) and the first detent contour (41) of the first movable indexing device (8) is disengaged.

18. The control device according to claim 3, characterized in that a contact switch (13) is provided which, by manual operation of the cap (21), actuates a linear actuator (14) which moves the vertically movable component (10) in the vertical direction for the purpose of changing the indexing position.
